(19) United States
(12) Patent Application Publication
(10) Pub. No.: US 2017/0108019 A1
(43) Pub. Date: Apr. 20, 2017

(54) TRIPLE PISTONS CYLINDER WITH REDUCED OVERALL LENGTH

(71) Applicant: ILIE VELA, Kitchener (CA)

(72) Inventor: ILIE VELA, Kitchener (CA)

(21) Appl. No.: 14/886,086

(22) Filed: Oct. 18, 2015

(51) Int. Cl. F15B 15/16

(52) U.S. Cl. CPC F15B 15/16

(57) ABSTRACT

A triple piston fluid pressure cylinder is disclosed with a parallel arrangement of the pistons that allows a combination of the first two stages of the cylinder into one stage so that the first two stages of the cylinder are working into the same common space.

As the result of that arrangement the overall length of the triple pistons cylinder is reduced by a significant amount.

The saved length may be used to increase the stroke of the cylinder.

The piston body assembly is built around the piston arrangement, and is composed of a cylinder tube with one head end cover and one rod end cover and one middle fixed pistons.

The middle fixed piston is extended through an extension tube to an extension fixed piston.

This application claims the benefit of U.S. Provisional Application No. 62/065,827 filed Oct. 20, 2014

### BACKGROUND

Field of the Invention

The present invention relates to a fluid pressure cylinder that uses fluid pressure to displace a piston assembly in an axial direction relative to a cylinder body assembly.

Description of the Related Art

In many applications there is a need for higher forces developed by the actuator, or cylinder.

The solution existent so far is to stack multiple cylinders inline and that led to invention of the multiple piston cylinders that is practically a series of two or more pistons secured on a common rod, inside a cylinder body divided into multiple chambers.

The pistons under pressure exert an axial force on the rod and all the forces are summed and applied at the rod end of the cylinder.

The earliest patent regarding the multiple pistons cylinders are the U.S. Pat. No. 825,866 granted Jul. 10, 1906 to L. H. Rogers, U.S. Pat. No. 1,565,767 granted Dec. 1, 1922 to C. R. Westbrook, and U.S. Pat. No. 2,956,549 granted Jul. 5, 1955.

The multiple pistons cylinder has limitations regarding stroke, due to the overall length of such a cylinder.

Usually triple pistons cylinders go up to 3 or 4 inches of stroke as standard and higher strokes are custom build, and are usually extremely long, implying higher cost in building the cylinder and building longer and heavier support frames.

For example, every inch of extra stroke of the triple pistons cylinder generates three extra inches of length of the cylinder body.

### OBJECT OF THE INVENTION

The principal object of the present invention is to reduce the overall length of the triple piston cylinders.

Considering actual limits accepted by the industry that reduction of overall length will allow for an increased stroke of the cylinder.

### SUMMARY OF THE INVENTION

By definition the work volume of a piston in the multiple piston cylinders is called a stage. So the triple pistons cylinders have three stages.

The present invention is based on the inventor's observation, that the front two stages of a triple piston cylinder may be combined to use practically the same volume of work.

The present invention provides a solution that generates a reduction of one third of the overall length of a triple piston cylinder, compared with triple piston cylinders invented so far.

The piston assembly has a parallel arrangement of the pistons and not an inline arrangement like existing triple pistons cylinders.

The front piston is connected in parallel with the second and third piston.

The outside diameter of the front piston is connected to the internal dual piston through a piston tube and the inside diameter of the front piston is connected to the end piston through a piston rod.

The pistons arrangement generates the structure of the cylinder body assembly.

Similar to any other cylinders the body of such a cylinder is made of a cylinder tube that has a head end cover at one end and a rod end cover at the other end.

The difference consists of an additional middle fixed piston, attached inside on the cylinder tube and extended to an extension fixed piston through an extension tubular shaft.

The second piston of the piston assembly is a dual piston, meaning that the outside diameter of the dual piston is sliding on the inside surface of the cylinder tube and the inside diameter of the dual piston is sliding on the exterior surface of the extension tubular shaft.

The above and other objects, features and advantages of the present invention will become clearer through the following detailed description when taken together with the attached drawings.

### BRIEF DESCRIPTION OF THE DRAWINGS

FIG. 1 shows the overall cross sectional view of the preferred embodiment of a triple pistons fluid pressure cylinder with reduced overall length.

FIG. 2 shows the overall cross sectional view of the piston assembly of the preferred embodiment of a triple pistons fluid pressure cylinder with reduced overall length.

FIG. 3 shows the cross sectional view of the body assembly of the preferred embodiment of a triple pistons fluid pressure cylinder with reduced overall length.

FIG. 4 shows the overall cross sectional view of the second embodiment of a triple pistons fluid pressure cylinder with reduced overall length.

FIG. 5 shows the rod end view of the rod end cover with flats.

FIG. 6 shows the rod end view of the rod end cover without flats

### DETAILED DESCRIPTION

### Targeted Space of the Cylinder for Present Invention

The focus of the present invention was to combine the first two stages or the triple pistons cylinder into one common dual stage.

This endeavor led to a parallel arrangement of the three pistons of the cylinder.

The cylinder body was built around the pistons parallel arrangement.

### Preferred Embodiment

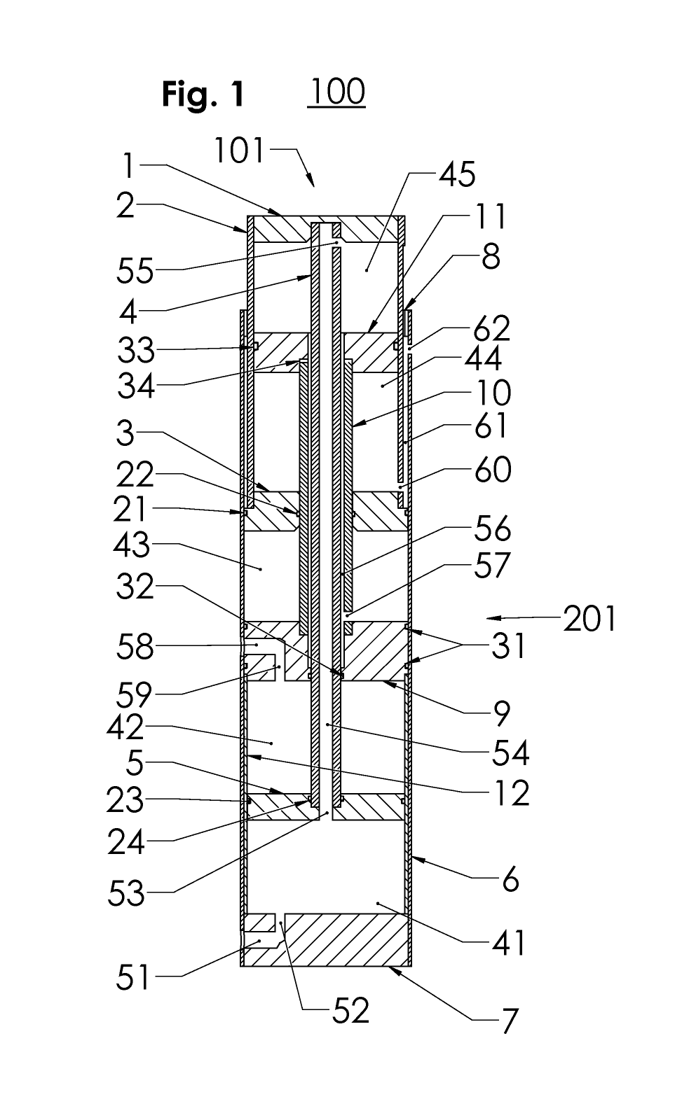

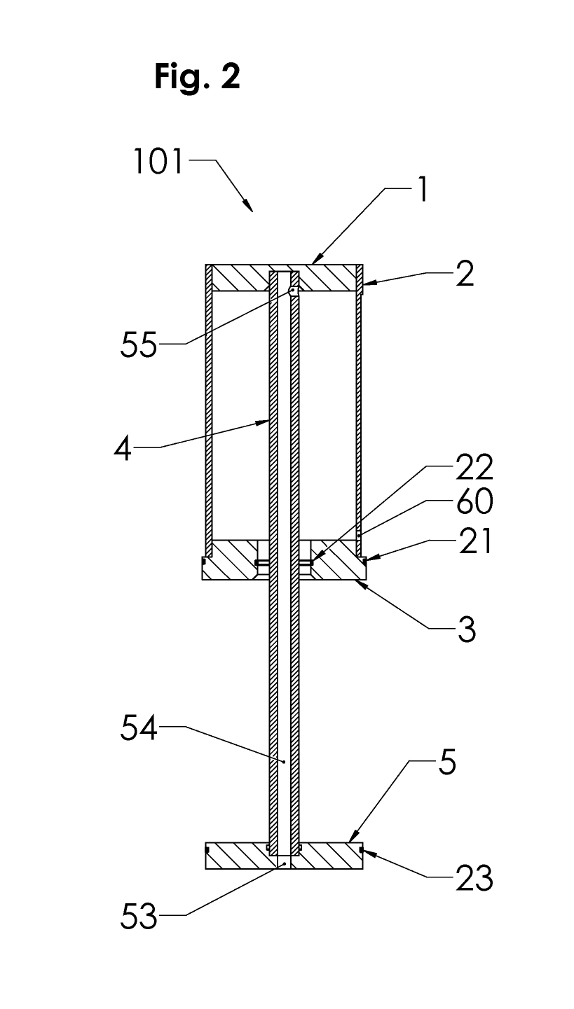

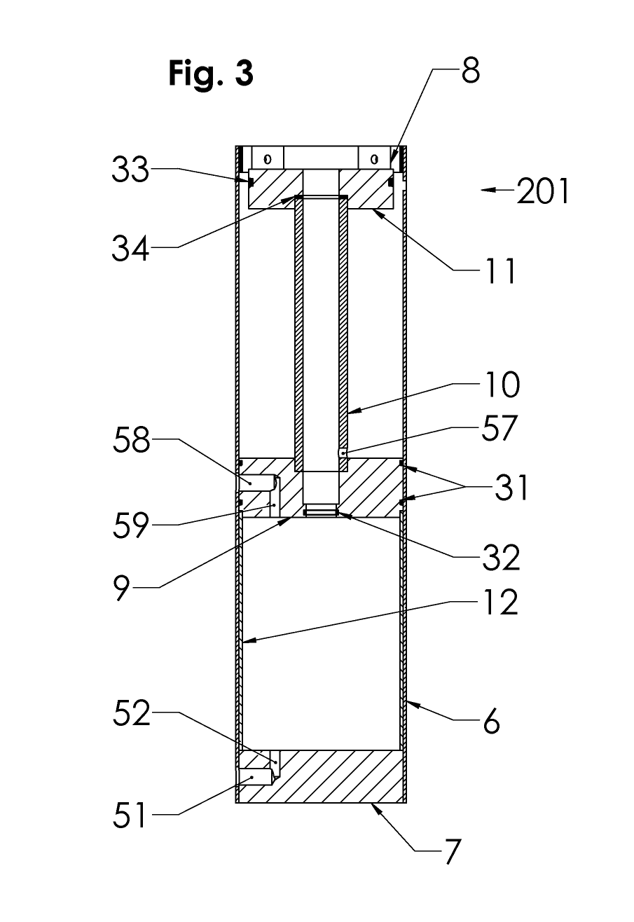

FIGS. 1, 2, 3 and 5 disclose such a cylinder.

The cylinder 100 is composed of a cylinder body assembly 201 and a piston assembly 101.

The cylinder piston assembly 101 is composed of an external piston 1 attached to an internal dual piston 3 through the piston tube 2 and to an end piston 5 through a tubular piston rod 4.

Different devices can be attached on the exterior face of the external piston 1, like brackets, flanges, rod ends, studs, pivoting eyes, etc. that are well known in the art without departing from the scope of the present invention.

The end piston 5 has a central hole 53 continued with a rod through hole 54 and opening 55 that allow feeding cylinder chambers with pressurized fluid.

The cylinder body assembly 201 is composed of a cylinder tube 6 that has a head cover 7 attached at one end and a rod end cover 8 attached at the opposite end, a middle fixed piston 9 extended with an extension fixed piston 11 through an extension tubular shaft 10.

Back liner 12 supports and properly aligns the middle fixed piston 9.

Cylinder body tube 6 could be made as cylindrical, oval, square, rectangular or other shapes that are well known in the art without departing from the scope of the present invention.

Different devices can be attached on the exterior face of the head cover 7, like brackets, flanges, rod ends, studs, pivoting eyes, etc. that are well known in the art without departing from the scope of the present invention

Head cover 7 has an inlet port 51. Pressurizing port 51 will extend the piston assembly 101.

Middle fixed piston 9 has one inlet port 58. Pressurizing port 58 will retract the piston assembly 101.

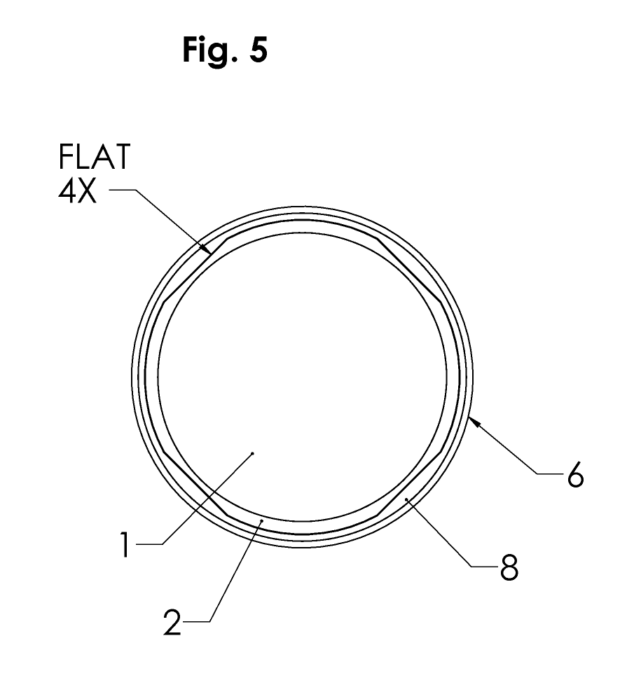

Rod end cover 8 is configured as a ring with flats as shown in FIG. 5, guiding the piston assembly 101 and functioning as both scraper and anti-rotate means.

Seals 23 and 24 are installed on the end piston 5 and seal the chambers 41 and 42.

Seals 31 and 32 are installed on the middle fixed piston 4 and seal the chambers 42 and 43.

Seals 21 and 22 are installed on the internal dual piston 3 and seal chambers 43 and 61.

Seals 33 and 34 are installed on the extension fixed piston and seal chambers 44 and 45.

Orifice 60 allows free fluid flow between chambers 44 and 61.

When pressurized fluid is applied to the inlet port 51, the pressure is built in the chamber 41 through opening 52, in chamber 45 through opening 53, through hole 54 and opening 55 and in chamber 43 through the chamber 56 and opening 57.

Extending forces are developed on the back of the pistons 5, 3 and 1, and the cylinder 100 extends.

While extending the fluid from chamber 42 is evacuated through the opening 59 and inlet port 58 and the fluid from chamber 44 is evacuated through the orifice 60 to chamber 61 and from there farther through the opening 62.

The force developed on the piston 3 is transferred to the piston 1 through the piston tube 2 and the force developed on the piston 5 is transferred to the piston 1 through the piston rod 4.

Cylinder extending force is a combination of the three forces developed in the pistons 1, 3 and 5.

To retract the cylinder pressurized fluid is applied at the inlet port 58 and will pressurize chamber 42 through the opening 59 developing a force on the piston 5 and the cylinder 100 retracts.

The fluid from chamber 43 is evacuated to the chamber 45 through opening 57 and chamber 56 and from chamber 45 to chamber 41 through opening 55 and through hole 54.

The fluid from chamber 41 is evacuated to exterior through opening 52 and inlet port 51

### Second Possible Embodiment

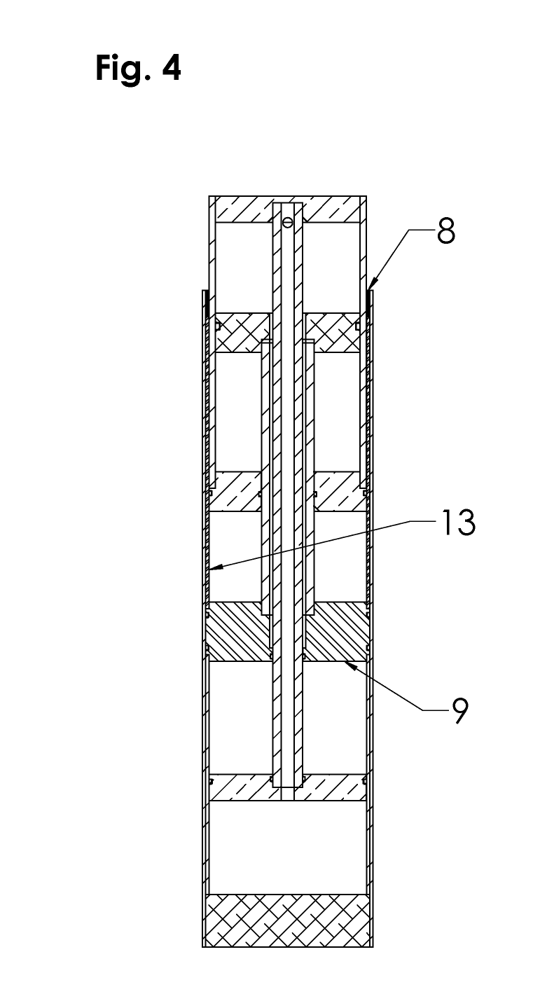

The FIG. 4 discloses a second possible embodiment of the present invention.

The cylinder is identical with the cylinder described as the preferred embodiment and has an additional liner 13 between the middle fixed piston 9 and rod end cover 8.

### More Possible Embodiments

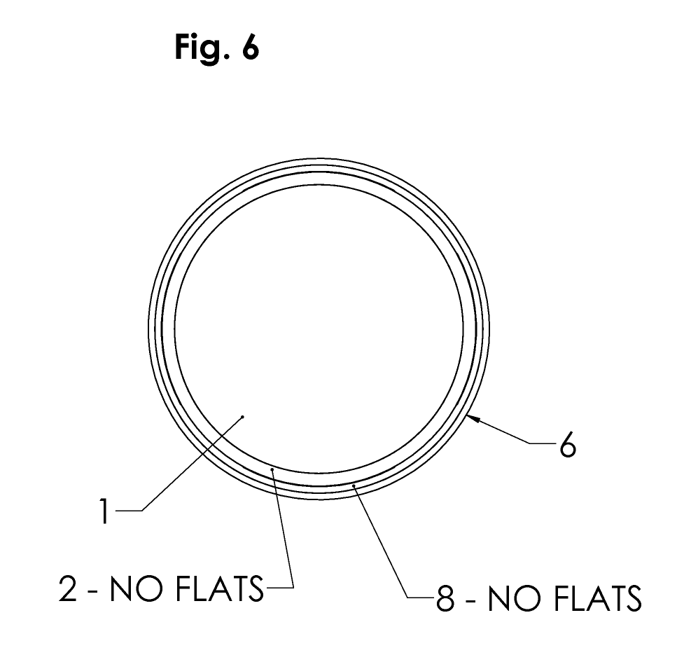

In case of applications where the rotation of the piston assembly 101 is not of interest, the flats on cover end 8 and piston tube 2 are not necessary, and the FIG. 6 shows such a configuration.

### INTENDED USE

The present invention may be used for applications that require an increased thrust force within limited spaces and related length restrictions accepted by the industry, like: a) clamping parts in fixtures for production processes in confined spaces, b) resistance welding cylinders that require high clamping force to produce a welding nugget, or c) processes that require the use of presses and stamping machines.

### REFERENCES

### United States Patents

| | | |
|---|---|---|
| 298,224 | May 6, 1884 | Morgan |
| 560,125 | May 12, 1896 | Falkenau, Hund |
| 715,598 | Dec. 9, 1902 | Philipp |
| 825,866 | Jul. 10, 1906 | Rogers |
| 896,571 | Aug. 18, 1908 | Ocain |
| 1,565,767 | Dec. 15, 1925 | Westbrook |
| 2,116,046 | May 3, 1938 | Schmutz |
| 2,383,082 | Aug. 21, 1945 | Rossmann |
| 2,743,703 | May 1, 1956 | Miller |
| 2,956,549 | Oct. 18, 1960 | Malpass |
| 2,981,234 | Apr. 25, 1961 | Appleton |
| 2,983,256 | May 9, 1961 | Seeloff |
| 3,457,841 | Jul. 29, 1969 | Tregaskiss |
| 4,011,724 | May 15, 1977 | Landes, Thomas |
| 4,296,677 | Oct. 27, 1981 | Little, Green |
| 4,621,564 | Nov. 11, 1986 | Nishii |
| 5,245,911 | Sep. 21, 1993 | Yuda |
| 6,029,561 | Feb. 29, 2000 | Naslund, Disbo |
| 8,166,866 | May 1, 2012 | Lind, Faller |

### United States Patent Application Publication

| | | |
|---|---|---|
| 0305916 A1 | Nov. 21, 2013 | Broman |
| 0157981 A1 | Jun. 12, 2014 | Saito, Hara, Sato |

### European Patent Application Publication

| | | |
|---|---|---|
| 92307748.1 | Aug. 25, 1992 | Kao, Haw-Ran |
| 90304806.4 | May 3, 1990 | Hideo, Suzuki |

What is claimed is:

1. A fluid pressure cylinder comprising:
a.) a cylinder body assembly that is made of a cylinder tube with a head cover attached at one end and a rod end cover attached at the opposite end, and a middle fixed piston extended through an extension tubular shaft to an extension fixed piston,
b.) a cylinder piston assembly that is made of an external piston connected on the outside diameter to an internal dual piston through a piston tube and the inside diameter connected to an end piston through a piston rod,
c.) a set of seals that provide sealing means between: internal dual piston and extension shaft, internal dual piston and cylinder tube, extension piston and piston tube, extension piston and extension shaft, end piston and cylinder tube, end piston and piston rod, middle fixed piston and cylinder tube, and middle fixed piston and piston rod.

2. A fluid pressure cylinder as described in the claim 1, where the rod end cover and the piston tube have one or more flats to prevent piston assembly rotation.

3. A fluid pressure cylinder as described in the claim 1 or claim 2, where a liner is inserted between the middle fixed piston and the head cover.

4. A fluid pressure cylinder as described in the claim 3, where an additional liner is inserted between the middle fixed piston and the rod end cover.
